(19) United States
(12) Patent Application Publication
(10) Pub. No.: US 2007/0225020 A1
(43) Pub. Date: Sep. 27, 2007

(54) System and method for processing messages

(75) Inventor: Tzu Chien Chang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Mediatek Inc.

(21) Appl. No.: 11/385,500

(22) Filed: Mar. 21, 2006

(51) Int. Cl. H04Q 7/20

(52) U.S. Cl. 455/466

(57) ABSTRACT

A method of blocking a SMS (short message service) message in a mobile terminal is provided. A first message indicating an incoming SMS message is received. It is first determined whether a SMS function of the mobile terminal has been temporarily disabled. If yes, a second message indicating that the mobile terminal is out of memory space is generated. The second message is later sent to a server to discard the first message.

### BACKGROUND

The invention relates to messaging service, and in particular to methods and systems of blocking messages according to user settings.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Short message service (SMS) permits transmission of short messages between mobile phones, other handheld devices and even landline telephones. Short message services are developing rapidly throughout the world. An increasing trend towards spamming cell phone users through SMS, however, has prompted cellular service carriers to take steps against the practice, before it becomes a severe problem.

Conventionally, a user has to inform a cellular service provider to cease the short message service. In this case, all short messages targeted at the user will be neither saved at the server end, nor transmitted to a mobile communication terminal utilized by the user. Conventionally, a mobile phone cannot block a short message, irrespective of whether or not the subscriber (or recipient) wants to receive it, once it is transmitted to the subscriber's phone number. In a case, for example, where the subscriber goes abroad, there is no way to block a short message from his/her country, and additional fees are thus induced by receiving the message. These problems occur because, once a calling party transmits a short message to a subscriber of a mobile wireless terminal, the subscriber has no choice but to receive it.

### BRIEF SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of blocking a SMS (short message service) message in a mobile terminal is provided. A first message is received. It is determined whether a first flag exists in a storage device of the mobile terminal upon receipt of the first message, wherein the first flag specifies that a SMS function of the mobile terminal is temporarily disabled. When the first flag exists, the first message is discarded upon receipt, and a second message is generated indicating that the storage device of the mobile terminal is unavailable. The second message is sent to a server providing the SMS.

Also provided is a method of blocking a messaging service in a mobile terminal. A first message is received. It is determined whether a first flag exists in a storage device of the mobile terminal, specifying that a messaging function of the mobile terminal is temporarily disabled. When the flag exists, the first message is discarded upon receipt.

Also provided is a system of processing messages. The system comprises an interface, a storage device, and a processor. The interface receives a first message. The storage device stores the first message and a function flag specifying settings of the messaging function of the system. The processor checks the function flag upon receipt of the first message, and processes the first message accordingly.

Also provided is a mobile phone. The mobile phone comprises a processor, a communication device, and a storage device. The communication device receives a first message. The storage device stores the first message and a function flag specifying settings of the messaging function of the system. The processor checks the function flag upon receipt of the first message, and processes the first message accordingly.

### BRIEF DESCRIPTION OF DRAWINGS

The invention can be more fully understood by reading the subsequent detailed description and examples with references made to the accompanying drawings, wherein:

FIG. 1 is a block diagram of a short message service (SMS) system for a mobile terminal to which the invention is applied;

FIG. 2 is a block diagram of an embodiment of a mobile terminal of the invention;

FIGS. 3A˜3C are schematic views of embodiments of message processing method; and

FIG. 4 is a flowchart of an embodiment of a method of processing SMS messages.

### DETAILED DESCRIPTION OF INVENTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

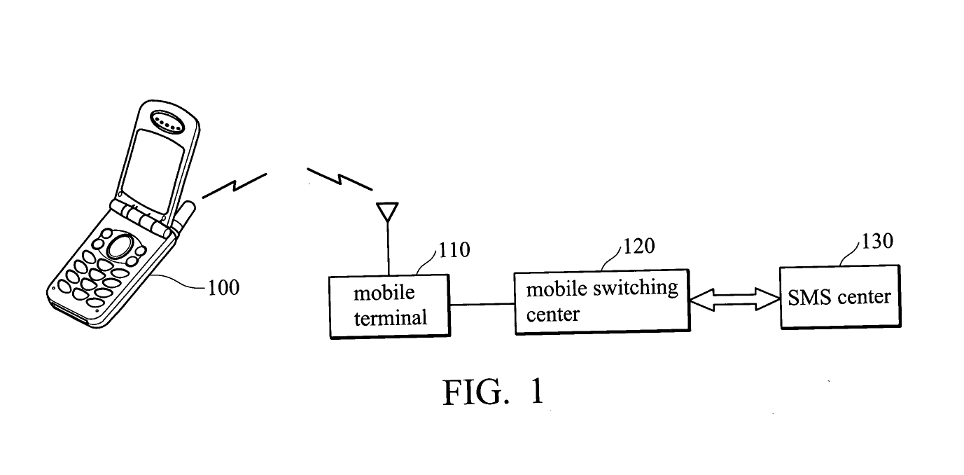

The invention is now described with reference to FIGS. 1 through 4, which generally relate to a short message service. In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

In the present invention, users can configure the SMS system of mobile devices based on individual demands. Users may just enable the SMS service to accept all incoming SMS messages and store them in a storage device of the mobile devices. In some situations, users may further delete unwanted incoming messages from the storage device automatically or mutually. On the other hand, users may disable the SMS service and stop receiving all incoming messages. For example, when too much junk messages are passed around, users could permanently disable the SMS service to avoid the disturbance. Or, sometimes, users may want to temporarily disable the SMS service. For example, while traveling abroad, to avoid being charged of too much roaming fee, users may prefer to temporarily stopping receiving the SMS messages and do it after return. More particularly, the present invention provides a method and system to temporarily stop the SMS service by sending a memory-full signal that informs the service operator device of not to transmit the incoming SMS messages now. Upon receiving the memory-full signal, the service operator device will keep all incoming SMS messages in a database and not inform users of those messages until the mobile device is ready to receive them, i.e. re-enable the SMS service. By the present invention, users have more options utilizing the SMS service.

It should be noted that the present invention can be applicable to the mobile devices that are capable of receiving SMS messages, such as mobile phones, smart phones, PDAs, and so on, via a communication network. The communication network can be GSM, GPRS, EDGE, and WCDMA communication systems.

Detail illustration of the method and system of the present invention will be explained as below.

FIG. 1 is a block diagram of a short message service (SMS) system for a mobile terminal to which the invention is applied. Referring to FIG. 1, a mobile terminal 100 transmits a short message to a base station 110. A mobile switching center 120 acknowledges receipt of the short message to mobile terminal 100, and transfers the received short message to another mobile radio terminal. An SMS (short message service) center 130, which is connected to other mobile switching centers (or to Public Switched Telephone Networks (PSTNs) and Integrated Services Digital Networks (ISDNs)), stores the short message received from mobile switching center 120 and transfers the short message to another mobile switching center.

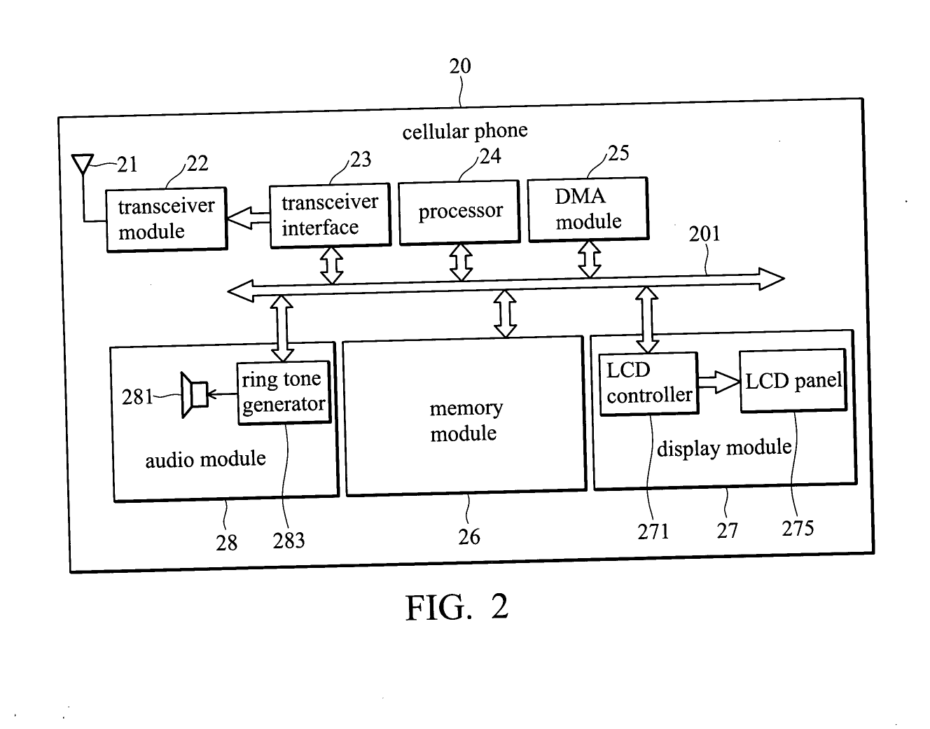

FIG. 2 is a block diagram of an embodiment of a mobile terminal of the invention. A mobile terminal 20, as shown in FIG. 2, includes an antenna 21, a transceiver module 22, a transceiver interface 23, a processor 24, a DMA module 25, a memory module 26, a display module 27, and an audio module 28. The audio module 28 comprises a speaker 281 and a ring tone generator 283.

The display module 27, comprising a LCD controller 271 and an LCD panel 275, visually presents information. An operating module (not shown), comprising a keyboard and/or a touch panel, inputs operational commands to the mobile terminal.

The antenna 21 receives and transmits radio signals, specifying voice signals and short messages. The transceiver module 22, connects to the antenna 21 and the transceiver interface 23, and receives and transmits radio signals via the antenna 21.

The memory module 26 stores short messages, function flags pertaining to the messaging function, operating programs, and other data. The speaker 281 emits audio signals, alarm signals, and other audible signals. A microphone (not shown) receives data for recording.

A signal modulating/demodulating module (not shown) modulates signals to be sent and demodulates received signals. The processor 24 controls operations of the mobile terminal according to programs stored in the memory module 26, and may be a central processing unit (CPU).

When an incoming message (first message) is received via the antenna 21, transceiver module 22, and transceiver interface 23, the processor 24 checks whether a flag is present in memory module 26 of the mobile terminal 20 upon receipt. The flag stored in memory module 26 specifies that a SMS function of the mobile terminal 20 is temporarily disabled. When the flag exists, processor 24 discards the first message upon receipt by generating a second message indicating that the memory module 26 of the mobile terminal 20 is full and no memory space is unavailable. The processor 24 then sends the second message to a server providing the SMS.

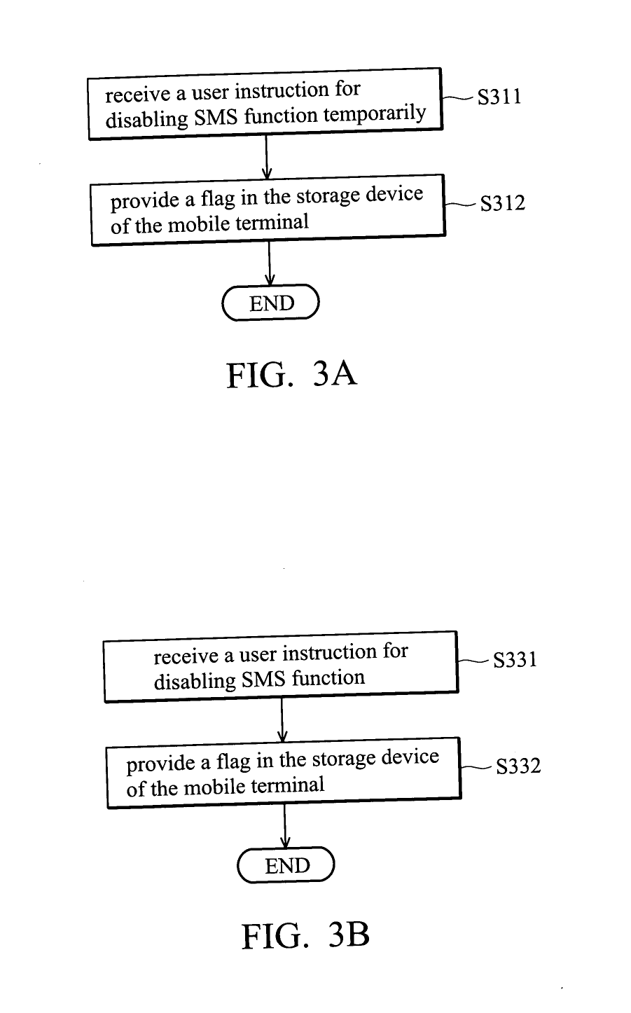

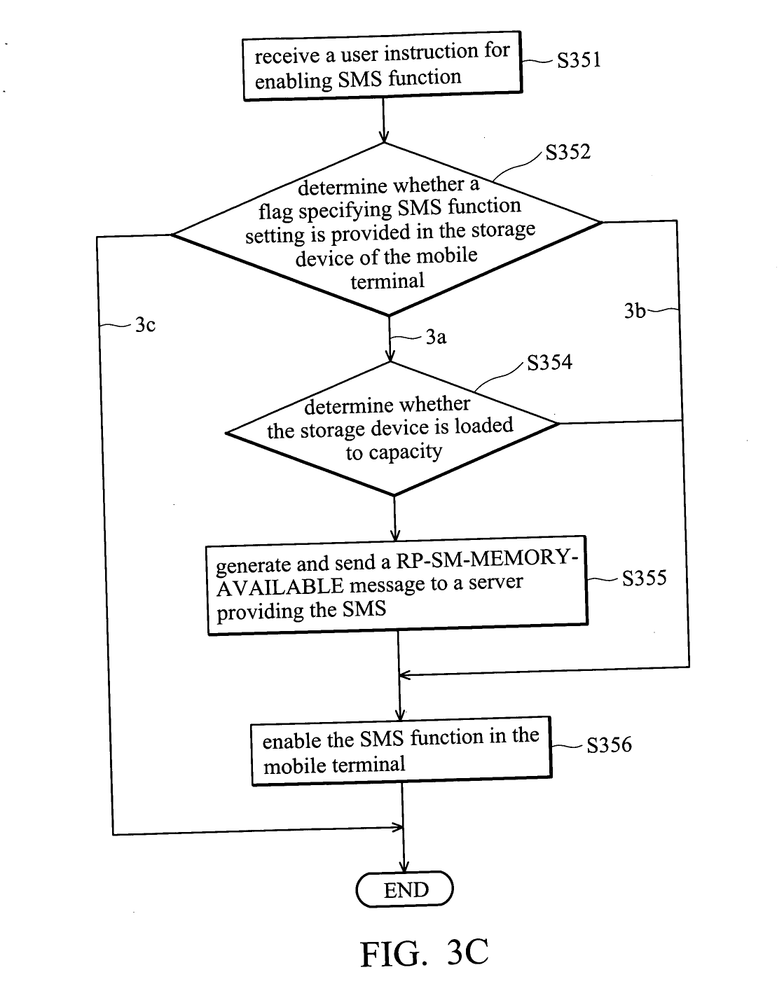

Referring to FIG. 3A, a first embodiment of a method of blocking SMS messages is illustrated. The method illustrated in FIG. 3A can be implemented in the mobile terminal of FIG. 2. The method of FIG. 3A illustrates a flowchart of temporarily blocking SMS messages in a mobile terminal. In step S311, a user instruction to temporarily disable SMS function is received. In step S312, a flag is provided in the storage device of the mobile terminal, specifying that SMS function of the mobile terminal has been temporarily disabled.

Referring to FIG. 3B, a second embodiment for a method of blocking SMS messages is illustrated. The method illustrated in FIG. 3B can be implemented in the mobile terminal of FIG. 2. FIG. 3B is a flowchart showing SMS messages blocked in a mobile terminal. In step S331, a user instruction to disable SMS function is received. In step S332, a flag is provided in the storage device of the mobile terminal, specifying that SMS function of the mobile terminal has been permanently disabled.

Referring to FIG. 3C, another embodiment for a method of enabling SMS function is illustrated. The method illustrated in FIG. 3C can be implemented in the mobile terminal of FIG. 2. FIG. 3C is a flowchart showing SMS function enabled in a mobile terminal. In step S351, a user instruction to enable SMS function is received. In step S352, it is determined whether a flag specifying SMS function setting is provided in the storage device of the mobile terminal. If a flag specifying temporarily disabled SMS function is detected (3a), the method proceeds to step S354, if a flag specifying permanently disabled SMS function is detected (3b), the method proceeds to step S356. If a flag specifying enabled SMS function is detected (3c), the method ends. In step S354, it is determined whether the storage device has loaded to capacity, and if so, the method proceeds to step S356, otherwise to step S355. In step S355, a RP-SM-MEMORY-AVAILABLE message is generated and sent to a server providing the SMS. In step S356, the SMS function in the mobile terminal is enabled.

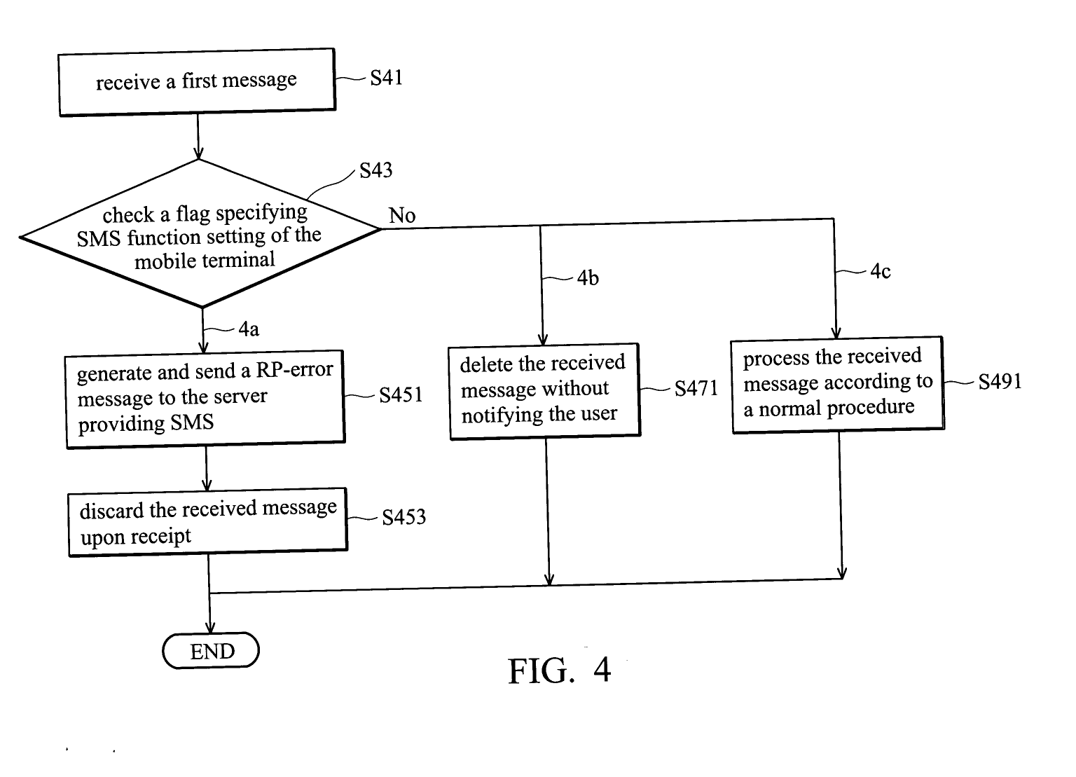

FIG. 4 is a flowchart of an embodiment of a method of processing SMS messages. A first message is received (step S41). A flag specifying SMS function setting of the mobile terminal is checked in step S43. If a flag specifying temporarily disabled SMS function is detected (4a), the method proceeds to step S451. If a flag specifying permanently disabled SMS function is detected (4b), the method proceeds to step S471. If a flag specifying enabled SMS function is detected (4c), the method proceeds to step S491.

In step S451, a RP-error message is generated and sent to the server providing SMS. The RP-error message indicates that the memory device has loaded to capacity. The RP-error message is specified according to a SMS standard. In step S453, the received message is discarded upon receipt, and no additional notification is issued.

In step S471, the received message is deleted without notifying the user.

In step S491, the received message is processed according to a normal procedure.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of blocking a SMS (short message service) message in a mobile terminal, comprising:
receiving a first message;
checking whether a SMS function of the mobile terminal has been temporarily disabled;
generating a second message indicating that the mobile terminal is out of memory space; and
sending the second message to a server providing the first message to discard the first message.

2. The method of claim 1, further comprising:
checking whether the SMS function of the mobile terminal has been permanently disabled.

3. The method of claim 1, wherein the second message is a RP-error message specified in SMS standard.

4. The method of claim 1, further comprising:
sending a third message indicating there are free memory space to receive a fourth message, and downloading the fourth message queued at the server.

5. The method of claim 4, wherein the third message is a RP-SM-MEMORY-AVAILABLE message specified in SMS standard.

6. A system of processing messages from a server, comprising:
an interface receiving a first message transmitted from the server; and
a controller, for checking whether a SMS function has been temporarily disabled, and for generating a second message indicating that the system is out of memory space, and for sending the second message to the server to discard the first message.

7. The system of claim 6, wherein the controller further checks whether the SMS function of the mobile terminal has been permanently disabled.

8. The system of claim 6, wherein the second message is a RP-error message specified in SMS standard.

9. The system of claim 6, wherein the controller further sends a third message indicating there are free memory space to receive a fourth message, and downloads the fourth message queued at the server.

10. The system of claim 9, wherein the third message is a RP-SM-MEMORY-AVAILABLE message specified in SMS standard.

11. A mobile phone communicating with a server, comprising:
a receiver for receiving a first message; and
a controller, for checking whether a SMS function has been temporarily disabled, and for generating a second message indicating that the mobile phone is out of memory space, and for sending the second message to the server to discard the first message.

12. The mobile phone of claim 11, wherein the controller further checks whether the SMS function of the mobile terminal has been permanently disabled.

13. The mobile phone of claim 11, wherein the second message is a RP-error message specified in SMS standard.

14. The mobile phone of claim 11, wherein the controller further sends a third message indicating there are free memory space to receive a fourth message, and downloads the fourth message queued at the server.

15. The mobile phone of claim 14, wherein the third message is a RP-SM-MEMORY-AVAILABLE message specified in SMS standard.
